(19) United States
(12) Patent Application Publication
(10) Pub. No.: US 2026/0302761 A1
(43) Pub. Date: Oct. 1, 2026

(54) SYSTEMS AND METHODS FOR OVER-TEMPERATURE PROTECTION FOR MOTOR-OPERATED APPLIANCES

(71) Applicant: Vita-Mix Management Corporation, Olmsted Township, OH (US)

(72) Inventors: Kellen Reusser, Brunswick, OH (US); Eric R. Miller, Olmsted Township, OH (US)

(73) Assignee: Vita-Mix Management Corporation, Olmsted Township, OH (US)

(21) Appl. No.: 19/478,300

(22) PCT Filed: May 23, 2024
(86) PCT No.: PCT/US2024/030712

§ 371 Date: Oct. 24, 2025

Related U.S. Application Data
(60) Provisional application No. 63/504,908, filed on May 30, 2023.

(51) Int. Cl. H02H 7/09; H02H 1/00

(52) U.S. Cl. CPC H02H 7/09; H02H 1/0007

(57) ABSTRACT

An appliance is disclosed including a motor and a motor protection system including a relay for permitting power to be provided to the motor when the relay is enabled and inhibiting power to be provided to the motor when the relay is disabled. The motor protection system also includes a PEC communicatively coupled to the relay and configured to disable the relay in response to determining that a fault condition is present and enable the relay in response to determining that the fault condition is not present. The fault condition is present when a voltage generated based on a detected temperature of the motor is less than a first predetermined voltage threshold range or greater than a second predetermined voltage threshold range.

### CROSS-REFERENCE TO RELATED APPLICATION

This application claims the benefit of co-pending U.S. Provisional Patent Application No. 63/504,908, filed May 30, 2023, for “Systems And Methods For Over-Temperature Protection For Motor-Operated Appliances, which is hereby incorporated by reference in its entirety including the drawings.

### TECHNICAL FIELD

The present specification generally relates to systems and methods for protecting a motor operated appliance when a temperature of the motor exceeds a predetermined temperature threshold and, more specifically, systems and methods for protecting an insulation system of a motor during such high temperature occurrences.

### BACKGROUND

Currently, a variety of devices are utilized to prevent overheating of a motor of an electrical device such that the motor is disabled when a temperature exceeding a predetermined threshold is detected. For example, a thermal cut-off (TCO) device is an electrical safety device designed to interrupt a circuit after a predetermined temperature is reached. A TCO can be one-time use device or resettable such as by being manually reset or automatically reset. In motor protection applications, a TCO is installed in series with the motor and is mounted directly to the motor. Other solutions include a positive temperature coefficient (PTC) thermistor. A PTC thermistor is an electrical device in which resistance is dependent on an operating temperature of the motor. Specifically, there is a positive relationship between resistance and temperature, for example, higher temperature results in higher resistance. The PTC thermistor uses the higher resistance to throttle the current being drawn by the motor. In motor protection applications, a PTC thermistor is also installed in series with the motor and is mounted directly to the motor. Additionally, a temperature sensor with microcontroller-based motor protection may be utilized to disable a motor when a temperature of the motor exceeds a predetermined temperature threshold. A temperature sensor such as, for example, a thermistor, an integrated circuit, a thermocouple, and the like, may be used to measure a temperature of the motor. A microcontroller receiving the detected temperature from the temperature sensor performs a particular safety operation such as, for example, stopping control signals to the motor, when the detected temperature of the motor is determined to exceed a predetermined threshold.

### SUMMARY

In one embodiment, an appliance includes: a motor; and a motor protection system including: a relay for permitting power to be provided to the motor when the relay is enabled and inhibiting power to be provided to the motor when the relay is disabled; and a protective electronic circuit (PEC) communicatively coupled to the relay, the PEC configured to: disable the relay in response to determining that a fault condition is present; and enable the relay in response to determining that the fault condition is not present, wherein the fault condition is present when a voltage generated based on a detected temperature of the motor is less than a first predetermined voltage threshold range or greater than a second predetermined voltage threshold range.

In another embodiment, a motor protection system includes: a relay for permitting power to be provided to a motor when the relay is enabled and inhibiting power to be provided to the motor when the relay is disabled; and a protective electronic circuit (PEC) communicatively coupled to the relay, the PEC configured to: disable the relay in response to determining that a fault condition is present; and enable the relay in response to determining that the fault condition is not present.

In yet another embodiment, a method includes: detecting a temperature of a motor of an appliance; disabling a relay supplying power to the motor of the appliance in response to determining that a fault condition is present; and energizing the relay such that the relay supplies power to the motor of the appliance in response to determining that the fault condition is not present, wherein the fault condition is present in response to determining that the temperature detected is less than a first predetermined voltage threshold range or greater than a second predetermined voltage threshold range.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a front view of an illustrative appliance, according to one or more aspects shown and described herein;

FIG. 2 schematically depicts a block diagram of components of the appliance, according to one or more embodiments shown and described herein; and

FIG. 3 schematically depicts a circuit diagram of components of the appliance, according to one or more embodiments shown and described herein; and

FIG. 4 depicts a flowchart of an illustrative method for preventing over-temperature protection for the appliance, according to one or more embodiments shown and described herein.

### DETAILED DESCRIPTION

Embodiments described herein are directed to systems and methods for over-temperature protection for motor-operated appliances. The appliance includes an appliance including a motor and a motor protection system including a relay for permitting power to be provided to the motor when the relay is enabled and inhibiting power to be provided to the motor when the relay is disabled. The motor protection system also includes a PEC communicatively coupled to the relay and configured to disable the relay in response to determining that a fault condition is present and enable the relay in response to determining that the fault condition is not present. The fault condition is present when a voltage generated based on a detected temperature of the motor is less than a first predetermined voltage threshold range or greater than a second predetermined voltage threshold range. Various embodiments of the appliance and operation of the appliance are described in more detail herein. Whenever possible, the same reference numerals will be used throughout the drawings to refer to the same or like parts.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

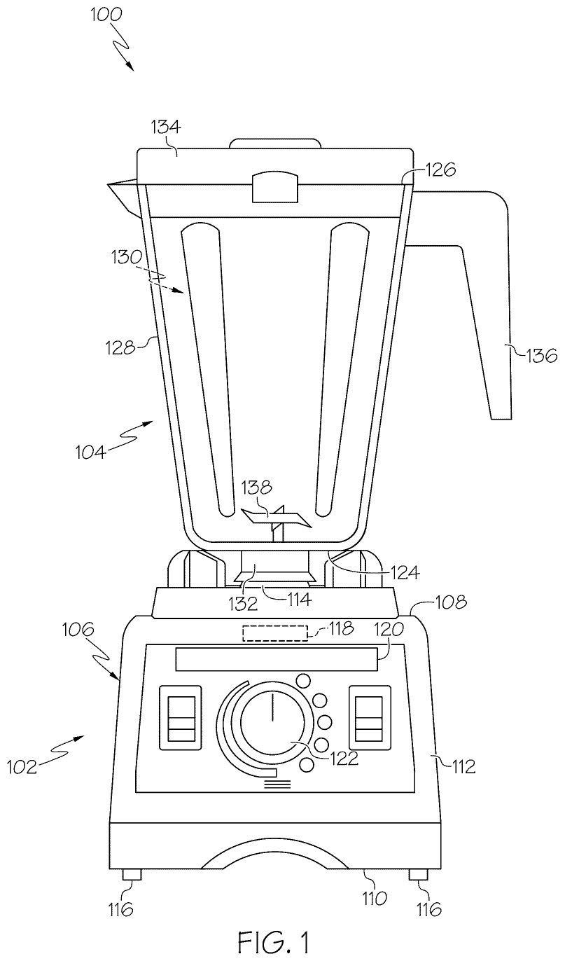

FIG. 1 generally depicts an illustrative appliance 100 according to various embodiments. As depicted in FIG. 1, the appliance 100 is illustrated as a blender. However, it should be appreciated that the appliance 100 may be any device such as, for example, air fryers, microwaves, food processors, coffee machines, hand mixers, stand mixers, and the like. The appliance 100 depicted in FIG. 1 may incorporate one or more sound dampening components, as described in greater detail herein. The appliance 100 depicted in FIG. 1 is provided for context only, and the sound dampening components described herein are not limited to this implementation. For example, the appliance 100 may include a large format container, or other blending container as described herein. In addition, the appliance 100 may allow for interchangeable containers.

As shown in FIG. 1, the appliance 100 includes a blender base 102 and a container 104 operatively attachable to the blender base 102.

The blender base 102 includes a housing 106 including an upper surface 108, a lower surface 110 opposite the upper surface 108, and an exterior wall 112 extending between the upper surface 108 and the lower surface 110. The housing 106 includes a container receiving member 114 provided at the upper surface 108 of the housing 106 for facilitating engagement with the container 104. In embodiments, the housing 106 includes one or more feet 116 provided at the lower surface 110 of the housing 106.

The housing 106 stores various electronic components, such as a motor 118, described in more detail herein. In embodiments, the blender base 102 includes a display device 120 and a tactile operating device 122 provided within the exterior wall 112 of the housing 106 so as to be visible and accessible by an operator from outside of the housing 106. The display device 120 and the tactile operating device 122 are described in more detail herein. However, it should be appreciated that the display device 120 provides a visual indicator of operating conditions of the appliance 100 such as, for example, an operating mode, an error status, and the like. Additionally, the tactile operating device 122 may include any number of movable objects that each transform physical motion into a data signal such as, for example, a button, a switch, a knob, a microphone, or the like. In some embodiments, the display device 120 and the tactile operating device 122 are combined as a single module.

The container 104 includes a bottom surface 124, an open top end 126 opposite the bottom surface 124, and a wall 128 extending between the bottom surface 124 and the open top end 126. The container 104 may be formed from one or more materials such as, but not limited to, plastics, glass, metals, or the like. The bottom surface 124 and the wall 128 define an interior cavity 130 of the container 104. The container 104 includes a container engagement member 132 provided at the bottom surface 124 of the container 104 that mates with the container receiving member 114 of the blender base 102 to couple the container 104 to the blender base 102.

The container 104 includes a lid 134 provided at the open top end 126 that may be operatively attached to the container 104 to enclose the interior cavity 130. In embodiments, the container 104 includes a handle 136 for assisting in removing the container 104 from the blender base 102. In some embodiments, the blender base 102 may identify or detect whether the container 104 is engaged with the blender base 102 through mechanical detection (e.g., push rods), user input, image recognition, magnetic detection (e.g., reed switches), electronic detection (e.g., inductive coils, a near field communication (NFC) component), or the like.

The container 104 includes a blade 138 provided within the interior cavity 130. In some embodiments, the blade 138 is removably couplable to the container 104. In addition, the container 104 may be removable couplable to the blender base 102 and extends through the bottom surface 124 of the container 104 to be provided within the interior cavity 130. The blade 138 may be rotated, moved, or the like by an external source, such as the motor 118 or the like. Accordingly, foodstuff may be added to the interior cavity 130 of the container 104 for blending. As a result of the motor 118 operating the blade 138, the blade 138 may agitate, impart heat, or otherwise interact with contents within the interior cavity 130 of the container 104. In some aspects, operation of the appliance 100 may impart heat into the contents within the interior cavity 130 of the container 104, such as through a magnet and an exciter that operatively induce heat through rotation of the magnet relative the exciter.

While the container 104 depicted in FIG. 1 is shown as a large-format system, the container 104 may be a single serving style container, such as for example, of a type where the container 104 is filled, the blender base 102 containing the blade 138 is attached to the container 104, and the container 104 is inverted and placed on the blender base 102 for blending. As can be appreciated, the container 104 depicted in FIG. 1 is only one illustrative shape, and the container 104 may be a different size and/or shape without departing from the scope of the present disclosure.

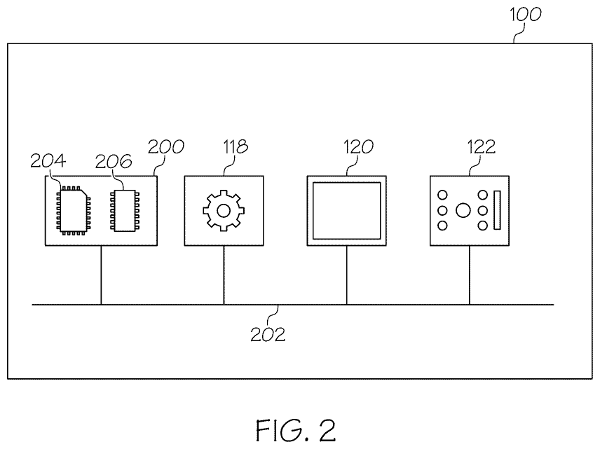

Referring now to FIG. 2, various components of the appliance 100 are schematically depicted. Specifically, the appliance 100 includes a controller 200, a communication path 202, the motor 118, the display device 120, and the tactile operating device 122. The various components of the appliance 100 and the interaction thereof will be described in detail below. However, it should be noted that, in embodiments, the appliance 100 may not include each of the various components discussed herein and, in other embodiments, the appliance 100 may include additional components not discussed herein.

As noted above, the appliance 100 includes the communication path 202. The communication path 202 may be formed from any medium that is capable of transmitting a signal such as, for example, conductive wires, conductive traces, optical waveguides, or the like. Moreover, the communication path 202 may be formed from a combination of mediums capable of transmitting signals. In one embodiment, the communication path 202 includes a combination of conductive traces, conductive wires, connectors, and buses that cooperate to permit the transmission of electrical data signals to components such as processors, memories, sensors, input devices, output devices, and communication devices. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. The communication path 202 communicatively couples the various components of the appliance 100. As used herein, the term “communicatively coupled” means that coupled components are capable of exchanging data signals with one another such as, for example, electrical signals via conductive medium, electromagnetic signals via air, optical signals via optical waveguides, and the like.

As noted above, the appliance 100 includes the controller 200 including one or more processors 204 and one or more non-transitory memory modules 206. Each of the one or more processors 204 may be any device capable of executing machine readable instructions. Accordingly, each of the one or more processors 204 may be an integrated circuit, a microchip, a computer, or any other computing device. The one or more processors 204 are communicatively coupled to the other components of the appliance 100 by the communication path 202. Accordingly, the communication path 202 may communicatively couple any number of processors with one another, and allow the modules coupled to the communication path 202 to operate in a distributed computing environment. Specifically, each of the modules may operate as a node that may send and/or receive data.

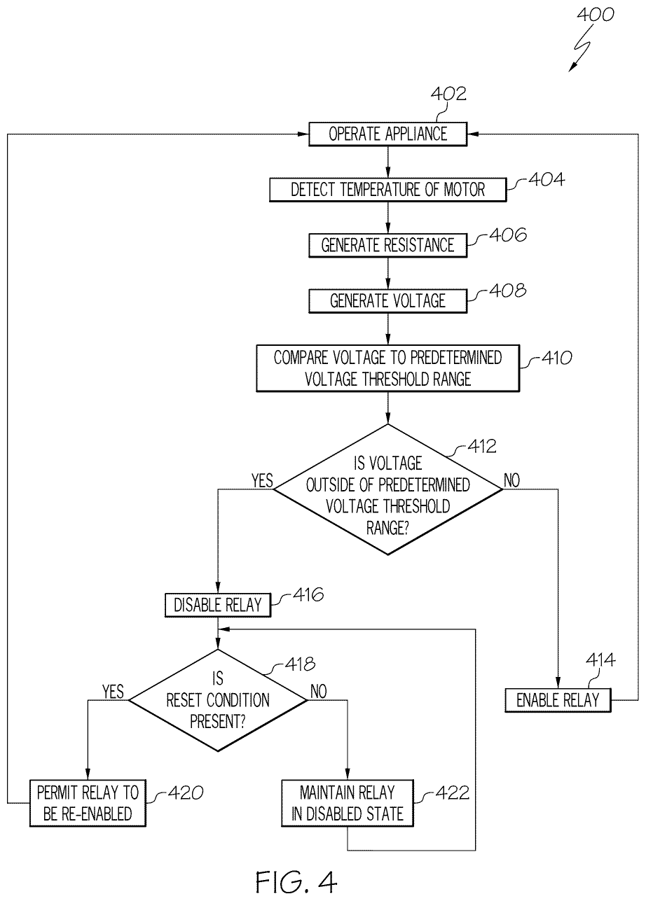

Each of the one or more memory modules 206 of the appliance 100 is coupled to the communication path 202 and communicatively coupled to the one or more processors 204. The one or more memory modules 206 may include RAM, ROM, flash memories, hard drives, or any device capable of storing machine readable instructions such that the machine readable instructions may be accessed and executed by the one or more processors 204. The machine readable instructions may include logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable instructions and stored on the one or more memory modules 206. In some embodiments, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. In embodiments, the one or more memory modules 206 includes machine readable instructions that, when executed by the one or more processors 204, cause the appliance 100 to perform the actions described below including the steps described in FIG. 4.

The appliance 100 includes the display device 120 for providing visual output such as, for example, notifications, alerts, or a combination thereof. The display device 120 is coupled to the communication path 202 and communicatively coupled to the one or more processors 204. Accordingly, the communication path 202 communicatively couples the display device 120 to other modules of the appliance 100. The display device 120 may include any medium capable of transmitting an optical output such as, for example, a cathode ray tube, light emitting diodes, a liquid crystal display, a plasma display, or the like. Moreover, the display device 120 may be a touchscreen that, in addition to providing optical information, detects the presence and location of a tactile input upon a surface of or adjacent to the display device 120. Accordingly, the display device 120 may receive mechanical input directly upon the optical output provided by the display device 120.

The appliance 100 includes the tactile operating device 122 coupled to the communication path 202 such that the communication path 202 communicatively couples the tactile operating device 122 to other modules of the appliance 100. The tactile operating device 122 may be any device capable of transforming mechanical, optical, or electrical signals into a data signal capable of being transmitted with the communication path 202. Specifically, the tactile operating device 122 may include any number of movable objects that each transform physical motion into a data signal that may be transmitted to over the communication path 202 such as, for example, a button, a switch, a knob, a microphone, or the like. In some embodiments, the display device 120 and the tactile operating device 122 are combined as a single module.

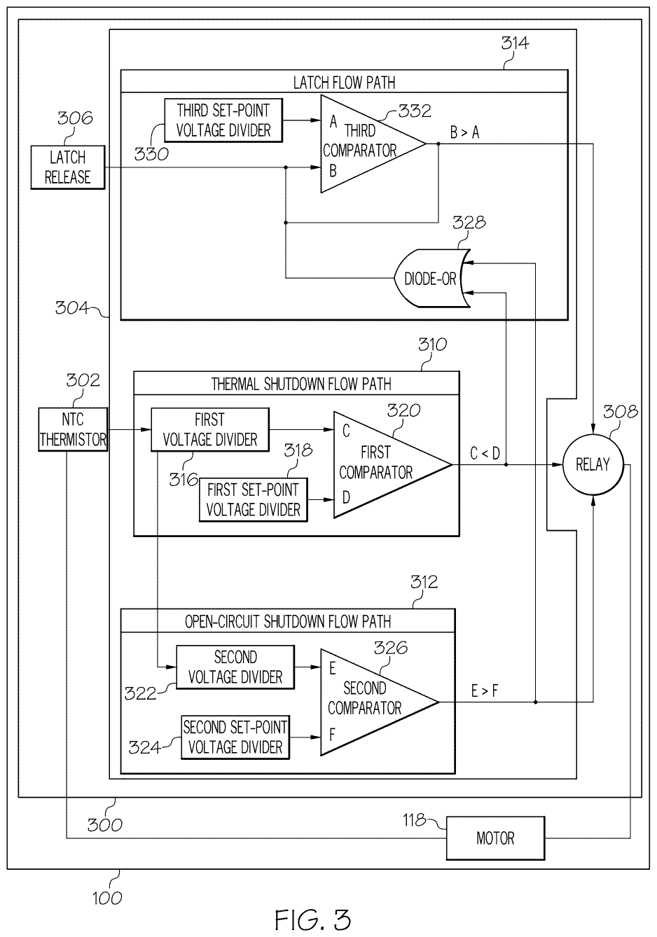

Referring now to FIG. 3, various electronic components of the appliance 100 are depicted. As shown in FIG. 3, the appliance 100 includes the motor 118 and a motor protection system 300 for controlling power being provided to the motor 118 to prevent over-temperature protection such as, for example, damage to the motor 118 or other components of the appliance 100 when a fault condition is present. Specifically, the motor protection system 300 includes a negative temperature coefficient (NTC) thermistor 302, a protective electronic circuit (PEC) 304, a latch release 306, and a relay 308 communicatively coupled to the PEC 304 for selectively permitting or inhibiting power from a power supply, either external or internal of the appliance 100, to be provided to the motor 118.

It should be appreciated that the determination steps below may be performed by the hardware discussed herein. In other embodiments, the motor protection system 300 may include the one or more processors 204 and the one or more memory modules 206 (FIG. 2), configured to carry out the determination steps below. More particularly, the PEC 304 of the motor protection system 300 includes a thermal shutdown flow path 310, an open-circuit shutdown flow path 312, and a latch flow path 314. As will be described in more detail herein, the relay 308 is communicatively coupled to the thermal shutdown flow path 310, the open-circuit shutdown flow path 312, and the latch flow path 314 such that the PEC 304 may selectively disable the relay 308 and, thus, prevent the motor 118 from being operated when it is determined, such as by the controller 200 (FIG. 2) that a fault condition is present. In embodiments, the fault condition is present when it is determined that a detected voltage falls outside of a predetermined voltage threshold range, as described in more detail herein. The motor 118 may be prevented from being operated so long as the fault condition is present. Once the fault condition is no longer present such as, for example, the detected voltage is within the predetermined voltage threshold range, the PEC 304 may permit the relay 308 to be enabled such that the motor 118 may be operated. Although referred to herein as a predetermined voltage threshold “range”, it should be appreciated that a single value may be utilized as opposed to a range.

With more particularity, the NTC thermistor 302 is mounted to the motor 118 to detect a temperature of coils of the motor 118. Based on the detected temperature of the coils of the motor 118, the NTC thermistor 302 generates a resistance that is inversely proportional to the detected temperature. Accordingly, as the temperature of the coils of the motor 118 increases, the resistance at the NTC thermistor 302 decreases. Alternatively, as the temperature of the coils of the motor 118 decreases, the resistance generated by the NTC thermistor 302 increases.

The thermal shutdown flow path 310 includes a first voltage divider 316 communicatively coupled to the NTC thermistor 302. The first voltage divider 316 generates a voltage, referred to herein as an input voltage C, based upon the resistance of the NTC thermistor 302. Based on the resistance generated by the NTC thermistor 302, the first voltage divider 316 generates a voltage that is proportional to the generated resistance. Accordingly, as the resistance generated by the NTC thermistor 302 increases, in response to a decreased detected temperature at the motor 118 (FIG. 2), the voltage generated by the first voltage divider 316 also increases. Alternatively, as the resistance generated by the NTC thermistor 302 decreases, in response to an increased detected temperature at the motor 118, the voltage generated by the first voltage divider 316 also decreases.

The thermal shutdown flow path 310 includes a first set-point voltage divider 318 that provides a first predetermined voltage threshold range D. The first voltage divider 316 and the first set-point voltage divider 318 are communicatively coupled to a first comparator 320 for comparing the input voltage C received from the first voltage divider 316 to the first predetermined voltage threshold range D received from the first set-point voltage divider 318. In embodiments, the first comparator 320 includes one or more digital comparators including one or more resistor networks tuned for input part-specific thresholds. In such embodiments, the digital comparator is utilized in place of any operational amplifiers. In embodiments, the first comparator 320 utilizes hysteresis to mitigate the effects of noise on the input voltage C from the first voltage divider 316.

If it is determined at the first comparator 320 that the input voltage C is less than the first predetermined voltage threshold range D, the fault condition is present and the first comparator 320, which is communicatively coupled to the relay 308, the first comparator 320 sends a signal to disable to the relay 308. Specifically, the fault condition determined by the first comparator 320 is indicative of an over-temperature condition of the motor 118 (FIG. 2). It should be appreciated that the thermal shutdown flow path 310 is a redundant flow path such that the first voltage divider 316 continuously collects a resistance from the NTC thermistor 302 and repeatedly compares the input voltage C to the first predetermined voltage threshold range D. Accordingly, the first comparator 320 is repeatedly and redundantly implemented to provide fault tolerance to the PEC 304.

The open-circuit shutdown flow path 312 includes a second voltage divider 322 similar communicatively coupled to the first voltage divider 316 for receiving the voltage from the first voltage divider 316. In embodiments, the first voltage divider 316 and the second voltage divider 322 are a single voltage divider. The second voltage divider 322 generates a voltage, referred to herein as an input voltage E.

The open-circuit shutdown flow path 312 includes a second set-point voltage divider 324 that provides a second predetermined voltage threshold range F. In embodiments, the first set-point voltage divider 318 and the second set-point voltage divider 324 are a single set-point voltage divider. Accordingly, the first predetermined voltage threshold range D and the second predetermined voltage threshold range F may be the same.

The second voltage divider 322 and the second set-point voltage divider 324 are communicatively coupled to a second comparator 326 for comparing the input voltage E received from the second voltage divider 322 to the second predetermined voltage threshold range F received from the second set-point voltage divider 324. In embodiments, the second comparator 326 includes one or more digital comparators including one or more resistor networks tuned for input part-specific thresholds. In such embodiments, the digital comparator is utilized in place of any operational amplifiers. In embodiments, the second comparator 326 utilizes hysteresis to mitigate the effects of noise on the input voltage E from the second voltage divider 322.

If it is determined at the second comparator 326 that the input voltage E is greater than the second predetermined voltage threshold range F, the fault condition is present and the second comparator 326, which is communicatively coupled to the relay 308, sends a signal to disable to the relay 308. Specifically, the fault condition determined by the second comparator 326 is indicative of the motor 118 (FIG. 2) or some other component of the PEC 304 malfunctioning, for example, a missing, broken, or intermittent connection. When the relay 308 is disabled such that power is prevented from being provided to the motor 118, the display device (FIG. 1) of the appliance may provide a graphic display such as, for example, an error code, a light, or the like indicating that the motor 118 is not operational.

It should be appreciated that the open-circuit shutdown flow path 312 is a redundant flow path such that the second voltage divider 322 continuously collects a resistance from the NTC thermistor 302 via the first voltage divider 316 and repeatedly compares the input voltage E to the second predetermined voltage threshold range F. Accordingly, the second comparator 326 is repeatedly and redundantly implemented to provide fault tolerance to the PEC 304. In embodiments, the first comparator 320 and the second comparator 326 are a single comparator.

The latch flow path 314 includes a diode-OR 328 communicatively coupled to the first comparator 320 and the second comparator 326. The diode-OR 328 is utilized to isolate the voltages being provided by the thermal shutdown flow path 310 and the open-circuit shutdown flow path 312. As noted above, the motor protection system 300 includes the latch release 306, which operates to maintain the relay 308 in a disabled state once a fault condition is present, as determined by the thermal shutdown flow path 310 and/or the open-circuit shutdown flow path 312, and until a reset condition has been performed. In embodiments, the reset condition is present if the latch release 306 is actuated in software by user input. In other embodiments, the latch release 306 is a mechanical button of the tactile operating device 122 provided on the blender base 102 (FIG. 1) of the appliance 100. In other embodiments, the reset condition is present by a power reset cycle of the appliance 100, e.g., unplugging and restarting the appliance 100.

The latch flow path 314 includes a third set-point voltage divider 330 communicatively coupled to a third comparator 332. The third comparator 332 performs a binary comparison between a static function A and an operational input B. In embodiments, the static function A is set to a value of 0. In embodiments, the operational input B is set to a value of 1 when a fault condition is detected, even if no longer present. Accordingly, if one of the above criteria is met such that a fault condition is detected, even if no longer present, and the operational input B is set to a value of 1, which is greater than the static function A set to a value of 0, the third comparator 332 sends a signal to the relay 308 to maintain the relay 308 in the disabled state. As described in more detail herein, only when a reset condition is satisfied, such as by power cycling the appliance 100 or operating the latch release 306, is the operational input B set to 0 such that the third comparator 332 permits the relay 308 to be enabled, assuming a fault condition is no longer present.

Referring now to FIG. 4, and with reference to the appliance 100 illustrated in FIGS. 1-3, a method 400 is depicted for over-temperature protection for the appliance 100. Initially, at step 402, the appliance 100 is powered on and operated in a normal operating mode, e.g., without inhibiting power to the motor 118 of the appliance 100. During operation of the appliance 100, at step 404, the NTC thermistor 302, which is mounted to the motor 118 of the appliance 100, detects a temperature of the coils of the motor 118. At step 406, based on the detected temperature of the coils of the motor 118, the NTC thermistor 302 generates a resistance. As noted above, the resistance generated by the NTC thermistor 302 is inversely proportional to the detected temperature of the motor 118. Accordingly, as the temperature of the coils of the motor 118 increases, the resistance at the NTC thermistor 302 decreases. Alternatively, as the temperature of the coils of the motor 118 decreases, the resistance generated by the NTC thermistor 302 increases.

At step 408, the NTC thermistor 302 provides the resistance to the first voltage divider 316, which generates a voltage. As noted above, the voltage generated by the first voltage divider 316 is proportional to the resistance generated by the first voltage divider 316. Accordingly, as the resistance generated by the NTC thermistor 302 increases, in response to a decreased detected temperature at the motor 118, the voltage generated by the first voltage divider 316 also increases. Alternatively, as the resistance generated by the NTC thermistor 302 decreases, in response to an increased detected temperature at the motor 118, the voltage generated by the first voltage divider 316 also decreases.

At step 410, the first comparator 320 compares the voltage generated by the first voltage divider 316 to the first predetermined voltage threshold range D provided by the first set-point voltage divider 318. Additionally, at step 410, a second comparator 326 compares a voltage generated by the second voltage divider 322 to the second predetermined voltage threshold range F set by the second set-point voltage divider 324. In embodiments, the voltage generated by the second voltage divider 322 is equal to the voltage generated by the first voltage divider 316. Additionally, in embodiments, the predetermined voltage range set by the second set-point voltage divider 324 is equal to the predetermined voltage range set by the first set-point voltage divider 318.

As noted above, the first predetermined voltage threshold range D and the second predetermined voltage threshold range F are specific to the particular appliance 100. Accordingly, different predetermined voltage threshold ranges will be provided for other apparatuses. In embodiments, upper and lower values of the predetermined voltage threshold range may each be lower or higher. Additionally, in embodiments, a difference between upper and lower values of the predetermined voltage threshold range may be smaller or greater.

At step 412, a determination is made by the first comparator 320 and the second comparator 326 as to whether the voltage generated by the first voltage divider 316 or the voltage generated by the second voltage divider 322 are outside of the predetermined voltage threshold ranges, i.e., whether a fault condition is present. If the first voltage and the second voltage are each within the predetermined voltage threshold ranges, a fault condition is not present and the method 400 proceeds to step 414 at which a signal is sent to the relay 308 to enable the relay 308. Thus, the relay 308 permits power to be provided to the motor 118 and the motor 118 to operate, or continue operating if the relay 308 is already enabled. Thereafter, the method 400 returns to step 402 at which the appliance 100 is continued to operate. Accordingly, the steps 404-412 redundantly repeat to continue monitoring whether the relay 308 should be disabled if a fault condition is present.

Alternatively, if it is determined at step 412 that the first voltage or the second voltage are outside of the predetermined voltage threshold ranges, a fault condition is present and the method 400 proceeds to step 416 at which a signal is sent to the relay 308 to disable the relay 308. Thus, the relay 308 inhibits power to be provided to the motor 118 and the motor 118 is de-energized, or remains de-energized if the relay 308 is already disabled.

Thereafter, at step 418, a determination is made as to whether a reset condition is present so as to permit the relay 308 to be re-enabled and, thus, re-energize the motor 118. As discussed herein, a reset condition is present when it is determined that a power reset cycle of the appliance 100 has been performed or the latch release 306 is operated. As noted herein, the latch release 306, in embodiments, is instructed by software in response to receiving user input.

Accordingly, if it is determined at step 418 that a reset condition is present, e.g., a power reset cycle has been performed or the latch release 306 has been operated, the method 400 proceeds to step 420 at which the relay 308 is permitted to be re-enabled. Thus, the method 400 returns to step 402 at which the appliance 100 is continued to operate and subsequently confirm that a fault condition is no longer present at step 412.

Alternatively, if it is determined at step 418 that a reset condition is not present, e.g., a power reset cycle has not been performed and the latch release 306 has not been operated, the method 400 proceeds to step 422 to maintain the relay 308 in the disabled state. Thereafter, the method 400 returns to step 418 such that the relay 308 is maintained in the disabled state, despite a fault condition no longer being present, until it is determined at step 418 that a reset condition is present. The loop between steps 418 and 422 is reset once a reset condition is present and the method 400 returns to step 402 at which the appliance 100 is continued to operate and subsequently confirm that a fault condition is no longer present at step 412.

From the above, it is to be appreciated that defined herein is an appliance including a motor and a motor protection system including a relay for permitting power to be provided to the motor when the relay is enabled and inhibiting power to be provided to the motor when the relay is disabled. The motor protection system also includes a PEC communicatively coupled to the relay and configured to disable the relay in response to determining that a fault condition is present and enable the relay in response to determining that the fault condition is not present. The fault condition is present when a voltage generated based on a detected temperature of the motor is less than a first predetermined voltage threshold range or greater than a second predetermined voltage threshold range.

Further aspects of the embodiments described herein are provided by the subject matter of the following clauses:

An appliance comprising: a motor; and a motor protection system comprising: a relay for permitting power to be provided to the motor when the relay is enabled and inhibiting power to be provided to the motor when the relay is disabled; and a protective electronic circuit (PEC) communicatively coupled to the relay, the PEC configured to: disable the relay in response to determining that a fault condition is present; and enable the relay in response to determining that the fault condition is not present, wherein the fault condition is present when a voltage generated based on a detected temperature of the motor is less than a first predetermined voltage threshold range or greater than a second predetermined voltage threshold range.

The appliance of any preceding clause, further comprising: a negative temperature coefficient (NTC) thermistor mounted to the motor, the NTC thermistor generating a resistance based on a detected temperature of the motor.

The appliance of any preceding clause, further comprising: a thermal shutdown flow path including: a first voltage divider communicatively coupled to the NTC thermistor, the first voltage divider generating a voltage based on the resistance generated by the NTC thermistor; and a first comparator that determines whether the voltage generated by the first voltage divider is less than the first predetermined voltage threshold range.

The appliance of any preceding clause, wherein the first comparator sends a signal to disable the relay in response to determining the voltage generated by the first voltage divider is less than the first predetermined voltage threshold range.

The appliance of any preceding clause, further comprising: an open-circuit shutdown flow path including: a second voltage divider communicatively coupled to the NTC thermistor, the second voltage divider generating a voltage based on the resistance generated by the NTC thermistor; and a second comparator that determines whether the voltage generated by the second voltage divider is greater than the second predetermined voltage threshold range.

The appliance of any preceding clause, wherein the second comparator sends a signal to disable the relay in response to determining the voltage generated by the second voltage divider is greater than the second predetermined voltage threshold range.

The appliance of any preceding clause, further comprising: a latch flow path communicatively coupled to the thermal shutdown flow path and the open-circuit shutdown flow path, the latch flow path including: a latch release; and a third comparator that determines whether a reset condition is present.

The appliance of any preceding clause, wherein the third comparator sends a signal to permit the relay to be re-enabled in response to determining the reset condition is present.

The appliance of any preceding clause, wherein the latch release is operated in response to receiving instruction from software or performing a power reset cycle.

A motor protection system comprising: a relay for permitting power to be provided to a motor when the relay is enabled and inhibiting power to be provided to the motor when the relay is disabled; and a protective electronic circuit (PEC) communicatively coupled to the relay, the PEC configured to: disable the relay in response to determining that a fault condition is present; and enable the relay in response to determining that the fault condition is not present.

The motor protection system of any preceding clause, wherein the fault condition is present when a voltage generated based on a detected temperature of the motor is less than a first predetermined voltage threshold range.

The motor protection system of any preceding clause, further comprising: a thermal shutdown flow path including: a first voltage divider communicatively coupled to an NTC thermistor mounted to the motor, the first voltage divider generating a voltage based on a resistance generated by the NTC thermistor; and a first comparator that determines whether the voltage generated by the first voltage divider is less than the first predetermined voltage threshold range, wherein the first comparator sends a signal to disable the relay in response to determining the voltage generated by the first voltage divider is less than the first predetermined voltage threshold range.

A method comprising: detecting a temperature of a motor of an appliance; disabling a relay supplying power to the motor of the appliance in response to determining that a fault condition is present; and energizing the relay such that the relay supplies power to the motor of the appliance in response to determining that the fault condition is not present, wherein the fault condition is present in response to determining that the temperature detected is less than a first predetermined voltage threshold range or greater than a second predetermined voltage threshold range.

The method of any preceding clause, further comprising: detecting the temperature of the motor using a negative temperature coefficient (NTC) thermistor mounted to the motor, the NTC thermistor generating a resistance based on the detected temperature of the motor.

The method of any preceding clause, further comprising: generating a voltage at a first voltage divider based on the resistance generated by the NTC thermistor; and determining whether the voltage generated by the first voltage divider is less than the first predetermined voltage threshold range.

The method of any preceding clause, further comprising sending a signal to disable the relay in response to determining the voltage generated by the first voltage divider is less than the first predetermined voltage threshold range.

The method of any preceding clause, further comprising: generating a voltage at a second voltage divider based on the resistance generated by the NTC thermistor; and determining whether the voltage generated by the second voltage divider is greater than the second predetermined voltage threshold range.

The method of any preceding clause, further comprising sending a signal to disable the relay in response to determining the voltage generated by the second voltage divider is greater than the second predetermined voltage threshold range.

The method of any preceding clause, further comprising maintaining the relay in a disabled state until a reset condition is present.

The method of any preceding clause, further comprising sending a signal to enable the relay in response to determining the reset condition is present.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed is:

1. An appliance comprising:
a motor; and
a motor protection system comprising:
a relay for permitting power to be provided to the motor when the relay is enabled and inhibiting power to be provided to the motor when the relay is disabled; and
a protective electronic circuit (PEC) communicatively coupled to the relay, the PEC configured to:
disable the relay in response to determining that a fault condition is present; and
enable the relay in response to determining that the fault condition is not present,
wherein the fault condition is present when a voltage generated based on a detected temperature of the motor is less than a first predetermined voltage threshold range or greater than a second predetermined voltage threshold range.

2. The appliance of claim 1, further comprising:
a negative temperature coefficient (NTC) thermistor mounted to the motor, the NTC thermistor generating a resistance based on a detected temperature of the motor.

3. The appliance of claim 2, further comprising:
a thermal shutdown flow path including:
a first voltage divider communicatively coupled to the NTC thermistor, the first voltage divider generating a voltage based on the resistance generated by the NTC thermistor; and
a first comparator that determines whether the voltage generated by the first voltage divider is less than the first predetermined voltage threshold range.

4. The appliance of claim 3, wherein the first comparator sends a signal to disable the relay in response to determining the voltage generated by the first voltage divider is less than the first predetermined voltage threshold range.

5. The appliance of claim 4, further comprising:
an open-circuit shutdown flow path including:
a second voltage divider communicatively coupled to the NTC thermistor, the second voltage divider generating a voltage based on the resistance generated by the NTC thermistor; and
a second comparator that determines whether the voltage generated by the second voltage divider is greater than the second predetermined voltage threshold range.

6. The appliance of claim 5, wherein the second comparator sends a signal to disable the relay in response to determining the voltage generated by the second voltage divider is greater than the second predetermined voltage threshold range.

7. The appliance of claim 6, further comprising:
a latch flow path communicatively coupled to the thermal shutdown flow path and the open-circuit shutdown flow path, the latch flow path including:
a latch release; and
a third comparator that determines whether a reset condition is present.

8. The appliance of claim 7, wherein the third comparator sends a signal to permit the relay to be re-enabled in response to determining the reset condition is present.

9. The appliance of claim 7, wherein the latch release is operated in response to receiving instruction from software or performing a power reset cycle.

10. A motor protection system comprising:
a relay for permitting power to be provided to a motor when the relay is enabled and inhibiting power to be provided to the motor when the relay is disabled; and
a protective electronic circuit (PEC) communicatively coupled to the relay, the PEC configured to:
disable the relay in response to determining that a fault condition is present; and
enable the relay in response to determining that the fault condition is not present.

11. The motor protection system of claim 10, wherein the fault condition is present when a voltage generated based on a detected temperature of the motor is less than a first predetermined voltage threshold range.

12. The motor protection system of claim 11, further comprising:
a thermal shutdown flow path including:
a first voltage divider communicatively coupled to an NTC thermistor mounted to the motor, the first voltage divider generating a voltage based on a resistance generated by the NTC thermistor; and
a first comparator that determines whether the voltage generated by the first voltage divider is less than the first predetermined voltage threshold range,
wherein the first comparator sends a signal to disable the relay in response to determining the voltage generated by the first voltage divider is less than the first predetermined voltage threshold range.

13. A method comprising:
detecting a temperature of a motor of an appliance;
disabling a relay supplying power to the motor of the appliance in response to determining that a fault condition is present; and
energizing the relay such that the relay supplies power to the motor of the appliance in response to determining that the fault condition is not present,
wherein the fault condition is present in response to determining that the temperature detected is less than a first predetermined voltage threshold range or greater than a second predetermined voltage threshold range.

14. The method of claim 13, further comprising:
detecting the temperature of the motor using a negative temperature coefficient (NTC) thermistor mounted to the motor, the NTC thermistor generating a resistance based on the detected temperature of the motor.

15. The method of claim 14, further comprising:
generating a voltage at a first voltage divider based on the resistance generated by the NTC thermistor; and
determining whether the voltage generated by the first voltage divider is less than the first predetermined voltage threshold range.

16. The method of claim 15, further comprising sending a signal to disable the relay in response to determining the voltage generated by the first voltage divider is less than the first predetermined voltage threshold range.

17. The method of claim 16, further comprising:
generating a voltage at a second voltage divider based on the resistance generated by the NTC thermistor; and
determining whether the voltage generated by the second voltage divider is greater than the second predetermined voltage threshold range.

18. The method of claim 17, further comprising sending a signal to disable the relay in response to determining the voltage generated by the second voltage divider is greater than the second predetermined voltage threshold range.

19. The method of claim 18, further comprising maintaining the relay in a disabled state until a reset condition is present.

20. The method of claim 19, further comprising sending a signal to permit the relay to be re-enabled in response to determining the reset condition is present.
